(19) United States
(12) Patent Application Publication
(10) Pub. No.: US 2014/0145512 A1
(43) Pub. Date: May 29, 2014

(54) CONTACTLESS POWER TRANSMISSION DEVICE AND METHOD OF FABRICATING THE SAME

(71) Applicant: SAMSUNG ELECTRO-MECHANICS CO., LTD., Suwon (KR)

(72) Inventors: Kang Ryong CHOI, Suwon (KR); Ji Man RYU, Suwon (KR); Dong Hyeok CHOI, Suwon (KR); Chang Ryul JUNG, Suwon (KR); Sung Yong AN, Suwon (KR)

(73) Assignee: SAMSUNG ELECTRO-MECHANICS CO., LTD., Suwon (KR)

(21) Appl. No.: 13/775,787

(22) Filed: Feb. 25, 2013

(30) Foreign Application Priority Data
Nov. 27, 2012 (KR) 10-2012-0135254

(51) Int. Cl. H01F 38/14; H01F 41/00

(52) U.S. Cl. CPC H01F 38/14; H01F 41/00
USPC 307/104; 29/606

(57) ABSTRACT

There is provided a contactless power transmission device including a permanent magnet disposed at the center of a coil of a receiver in order to allow the center of the coil of the receiver and the center of a coil of a transmitter to coincide, and a coating layer formed on a surface of the permanent magnet.

### CROSS-REFERENCE TO RELATED APPLICATIONS

This application claims the priority of Korean Patent Application No. 10-2012-0135254 filed on Nov. 27, 2012, in the Korean Intellectual Property Office, the disclosure of which is incorporated herein by reference.

### BACKGROUND OF THE INVENTION

1. Field of the Invention

The present invention relates to a contactless power transmission device capable of wirelessly performing charging by using electromagnetic induction, and a method of fabricating the same.

2. Description of the Related Art

Research into a system for wirelessly, that is, contactlessly, transmitting power in order to charge a secondary battery embedded in a portable terminal, or the like, with power, has been recently conducted.

A contactless power transmission device generally includes a contactless power transmitter transmitting power and a contactless power receiver receiving and storing power therein.

A contactless power transmission device transmits and receives power using electromagnetic induction. To this end, an inner portion of each of the contactless power transmitter and the contactless power receiver is provided with a coil.

A contactless power receiver configured of a circuit part and a coil part is attached to a cellular phone case or an additional accessory tool in a form of a cradle to implement a function thereof.

Describing an operational principle of the contactless power transmission device, household alternating current (AC) power supplied from the outside is input from a power supply unit of the contactless power transmitter.

The input household AC power is converted into direct current (DC) power by a power converting unit, is re-converted into AC voltage having a specific frequency, and is then provided to the contactless power transmitter.

When the AC voltage is applied to the coil part of the contactless power transmitter, a magnetic field around the coil part is changed.

As the magnetic field of the coil part of the contactless power receiver disposed to be adjacent to the contactless power transmitter is changed, the coil part of the contactless power receiver outputs power to charge the secondary battery with power.

Charging efficiency becomes higher as strength of the magnetic field becomes greater and is affected by a shape of the coil, an angle at which the coil of the contactless power receiver and the coil of the contactless power transmitter meet each other, and the like.

B=μ₀·n·i [Equation 1]

In a general case, the strength of the magnetic field is increased in proportion to vacuum magnetic permeability (μ₀), turns (n) of a solenoid winding, and an amount of flowing current (i) as represented by Equation 1.

B=μ·μ₀·n·i [Equation 2]

In the case in which a permanent magnet is positioned at the center of the coil, the strength of the magnetic field is increased in proportion to vacuum magnetic permeability (μ₀), turns (n) of a solenoid winding, an amount of flowing current (i), and magnetic permeability (μ) of the permanent magnet as represented by Equation 2.

According to the related art, in order to allow the coil of the contactless power receiver and the coil of the contactless power transmitter to coincide, the permanent magnet is positioned in a central portion of the coil of the contactless power receiver.

In this case, the strength of the magnetic field is affected by the magnetic permeability (μ) of the permanent magnet as represented by Equation 2 above. However, the magnetic permeability (μ) of the permanent magnet may be very low, such that the strength of the magnetic field may be relatively weak.

Therefore, efficiency of the contactless power transmission device has also been decreased in proportion to a phenomenon in which the strength of the magnetic field is reduced due to the permanent magnet positioned in the central portion of the coil.

Therefore, a permanent magnet capable of allowing the coil of the contactless power receiver and the coil of the contactless power transmitter to coincide and increasing efficiency of the contactless power receiver has been demanded.

The following Related Art Document discloses a magnetic shield disposed on a rear surface of a receiving ferrite member of a contactless charging device, but does not disclose a configuration for a permanent magnet positioned at the center of a coil and has not disclosed a structure in which a permanent magnet having low magnetic permeability is supplemented by a metal layer having high magnetic permeability.

### RELATED ART DOCUMENT

Japanese Patent Laid-open Publication No. 2003-133125

### SUMMARY OF THE INVENTION

An aspect of the present invention provides a contactless power transmission device having improved efficiency and a method of fabricating the same.

According to an aspect of the present invention, there is provided a contactless power transmission device including: a permanent magnet disposed at the center of a coil of a receiver in order to allow the center of the coil of the receiver and the center of a coil of a transmitter to coincide; and a coating layer formed on a surface of the permanent magnet.

The coating layer may include at least one metal selected from a group consisting of iron, nickel, aluminum, silicon, cobalt, and zinc, or an alloy thereof.

The coating layer may include at least one of a sendust (Fe—Si—Al alloy) based high magnetic permeability material, a permalloy based high magnetic permeability material, and an amorphous based high magnetic permeability material.

A thickness of the coating layer may be 0.1 to 1.0 mm.

A diameter of an outermost portion of the coating layer may be 10 to 30 mm.

The coating layer may be formed on a cylindrical surface of the permanent magnet.

The permanent magnet may have a cylindrical shape or a rectangular parallelepiped shape.

The contactless power transmission device may be operated in a frequency range of 10 to 20,000 kHz.

According to another aspect of the present invention, there is provided a method of fabricating a contactless power transmission device, the method including: preparing a permanent magnet; forming a coating layer on the permanent magnet; and disposing the permanent magnet having the coating layer formed thereon at a central portion of a coil of a receiver.

The forming of the coating layer may be performed using at least one metal selected from a group consisting of iron, nickel, aluminum, silicon, cobalt, and zinc, or an alloy thereof.

The forming of the coating layer may be performed using a high magnetic permeability material including at least one of a sendust (Fe—Si—Al alloy) based high magnetic permeability material, a permalloy based high magnetic permeability material, and an amorphous based high magnetic permeability material.

The forming of the coating layer may be performed by one of a molecular beam epitaxy (MBE) method, a sputtering method, an electroplating method, an alloying method, and a dip-coating method.

The forming of the coating layer may be performed by one of a hydrothermal synthesis method, a pulsed laser deposition (PLD) method and an atomic layer deposition (ALD) method.

In the forming of the coating layer, the coating layer may be coated at a coating thickness of 0.1 to 1.0 mm.

The method may further include, after the forming of the coating layer, removing the coating layer formed on the permanent magnet.

In the preparing of the permanent magnet, the permanent magnet having a cylindrical shape or a rectangular parallelepiped shape may be prepared.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic perspective view of a contactless power transmission device according to an embodiment of the present invention;

FIG. 2 is a plan view of a permanent magnet of FIG. 1;

FIG. 3 is a schematic perspective view of a permanent magnet according to another embodiment of the present invention;

FIG. 4 is a flow chart of a method of fabricating a contactless power transmission device according to the embodiment of the present invention; and

FIG. 5 is a flow chart of a method of fabricating a contactless power transmission device according to another embodiment of the present invention.

### DETAILED DESCRIPTION OF THE EMBODIMENTS

Hereinafter, embodiments of the present invention will be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art.

In the drawings, the shapes and dimensions of elements may be exaggerated for clarity, and the same reference numerals will be used throughout to designate the same or like elements.

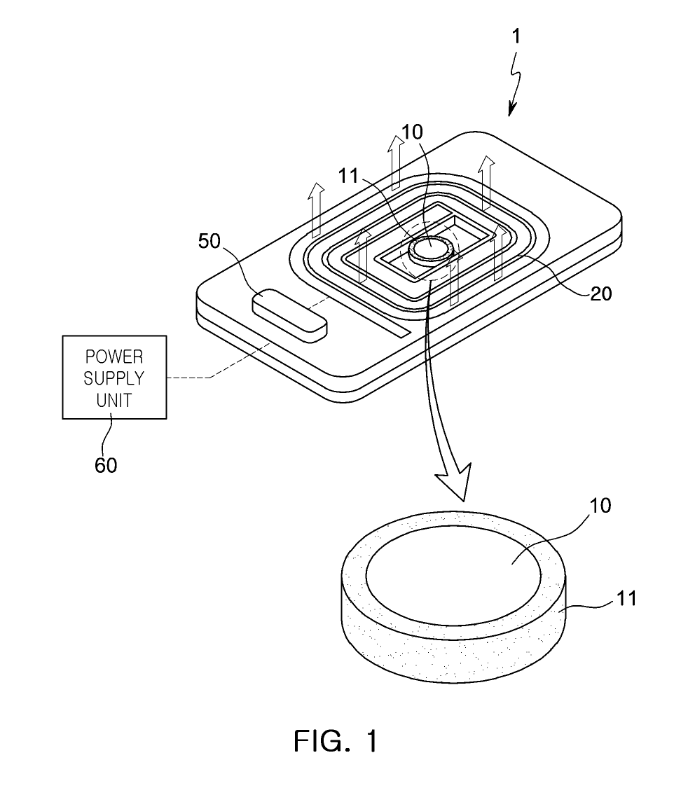

FIG. 1 is a schematic perspective view of a contactless power transmission device according to an embodiment of the present invention.

As shown in FIG. 1, the contactless power transmission device 1 according to the embodiment of the present invention may include a permanent magnet 10; and a coating layer 11 formed on a surface of the permanent magnet 10.

The contactless power transmission device 1 may include a coil 20 formed on the substrate.

The coil 20 may be formed in the vicinity of the permanent magnet 10.

The coil 20 of the contactless power transmission device 1 may include a single coil formed in a wiring pattern form on the substrate or a single coil pattern formed by connecting a plurality of coil strands in parallel with one another.

The coil 20 may be manufactured in a winding form or be manufactured in a flexible film form, but is not limited thereto.

The coil 20 transmits input power using an induced magnetic field or receives the induced magnetic field to allow the power to be output, thereby enabling contactless power transmission.

The contactless power transmission device 1 may include a power supply unit 60 and a power converting unit 50.

The power supply unit 60 may supply household alternating current (AC) power supplied from the outside to the power converting unit 50.

The input household AC power is converted into direct current (DC) power by the power converting unit 50, is re-converted into AC voltage having a specific frequency, and is then provided to the contactless power transmitter.

The contactless power transmission device 1 may be operated in a frequency range of 10 to 20,000 kHz.

In the case in which the coating layer 11 is formed of at least one metal selected from a group consisting of iron, nickel, aluminum, silicon, cobalt, and zinc, or an alloy thereof, or at least one of a sendust (Fe—Si—Al alloy) based high magnetic permeability material, a permalloy based high magnetic permeability material, and an amorphous based high magnetic permeability material, since the coating layer 11 has high magnetic permeability in the frequency range of 10 to 20,000 kHz, efficiency of the contactless power transmission device 1 may be increased.

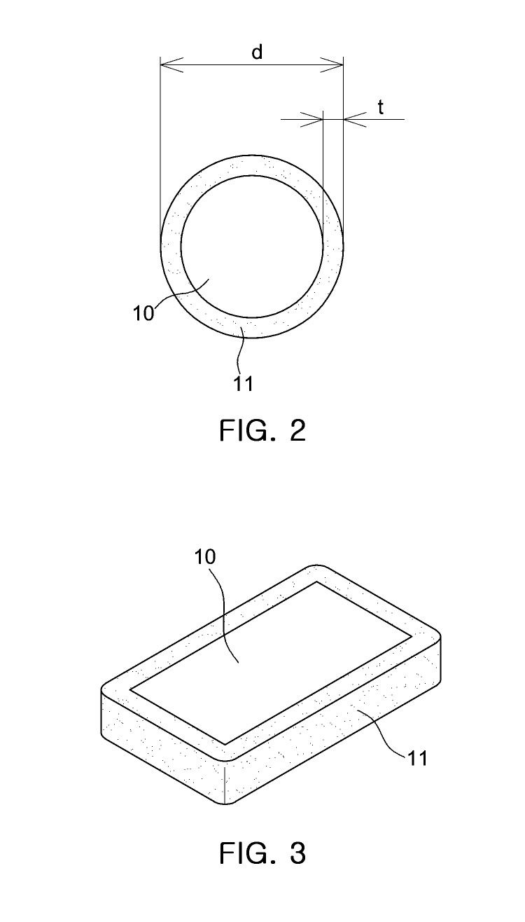

FIG. 2 is a plan view of a permanent magnet of FIG. 1.

Referring to FIGS. 1 and 2, the permanent magnet 10 may have a cylindrical shape and include the coating layer 11 formed on the surface thereof.

The permanent magnet 10 indicates a magnet of which a change in strength of residual magnetization due to magnetic disturbance from the outside is relatively low.

In addition, the permanent magnet 10 may be any one of an Nd—Fe based magnet, Sm₂Co₁₇ based magnet, a ferrite magnet, and an alnico magnet, but is not limited thereto.

The permanent magnet 10 may serve to allow the center of a coil of a contactless power receiver and the center of a coil of a contactless power transmitter to coincide.

The coating layer 11 may be formed in the vicinity of the permanent magnet 10 and be formed of a material having magnetic permeability higher than that of the permanent magnet 1.

A material of the coating layer 11 may be at least one metal selected from a group consisting of iron, nickel, aluminum, silicon, cobalt, and zinc, or an alloy thereof, but is not limited thereto.

In addition, a material of the coating layer 11 may be at least one of a sendust (Fe—Si—Al alloy) based high magnetic permeability material, a permalloy based high magnetic permeability material, and an amorphous based high magnetic permeability material, but is not limited thereto.

The coating layer 11 may be formed on a cylindrical surface of the permanent magnet 10.

In the case in which the coating layer 11 is only formed on the cylindrical surface of the permanent magnet 10, a magnetic field of the permanent magnet 11 is not blocked, such that a function of allowing a central portion of the coil of the contactless power receiver and a central portion of the coil of the contactless power transmitter to coincide may be improved, whereby efficiency of the contactless power transmission device 1 may be improved.

The coating layer 11 may be formed of a material having relatively high magnetic permeability to supplement the permanent magnet 10 having relatively low magnetic permeability (μ), thereby serving to increase the efficiency of the contactless power transmission device.

A thickness t of the coating layer may be 0.1 to 1 mm.

In the case in which the thickness t of the coating layer is 0.1 mm or more, a decrease in strength of a magnetic field due to the permanent magnet is alleviated, whereby the efficiency of the contactless power transmission device 1 may be increased.

Further, in the case in which the thickness t of the coating layer is 1 mm or less, the central portion of the coil of the contactless power receiver and the central portion of the coil of the contactless power transmitter are allowed to coincide using the permanent magnet 10, whereby the efficiency of the contactless power transmission device 1 may be increased.

In the case in which the thickness t of the coating layer is 0.1 mm or less, since the decrease in the strength of the magnetic field due to the permanent magnet 10 may not be prevented, an effect of increasing the efficiency of the contactless power transmission device 1 may be relatively low.

Further, in the case in which the thickness t of the coating layer exceeds 1 mm, the coating layer serves to block the magnetic field of the permanent magnet 10, such that the permanent magnet 10 may not serve to allow the central portion of the coil of the contactless power receiver and the central portion of the coil of the contactless power transmitter to coincide.

A diameter d of the outermost portion of the coating layer may be 10 to 30 mm.

In the case in which the diameter d of the outermost portion of the coating layer is 10 mm or more, the permanent magnet 10 serves to allow the central portion of the coil of the contactless power receiver and the central portion of the coil of the contactless power transmitter to coincide, whereby the efficiency of the contactless power receiver may be increased.

In the case in which the diameter d of the outermost portion of the coating layer is less than 10 mm, performance of the permanent magnet 10 of allowing the central portion of the coil of the contactless power receiver and the central portion of the coil of the contactless power transmitter to coincide may be decreased, whereby the efficiency of the contactless power receiver may not be increased.

In addition, in the case in which the diameter d of the outermost portion of the coating layer exceeds 30 mm, the permanent magnet 10 and the coating layer 11 may problematically contact the coil 20 formed in the vicinity thereof may occur.

FIG. 3 is a schematic perspective view of a permanent magnet according to another embodiment of the present invention.

The permanent magnet 10 according to another embodiment of the present invention may have a rectangular parallelepiped shape, but may also have other shapes. The permanent magnet 10 may be manufactured in a shape according to a shape of a core so that strength of a magnetic field may be increased. As the strength of the magnetic field is increased, an increase in the efficiency of the contactless power transmission device 1 may be expected.

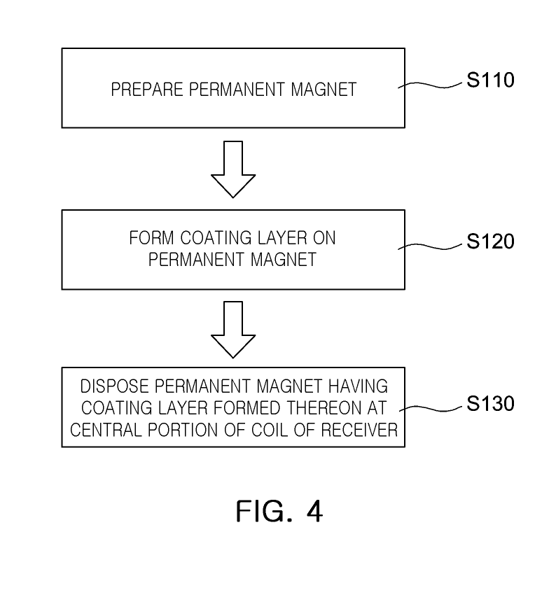

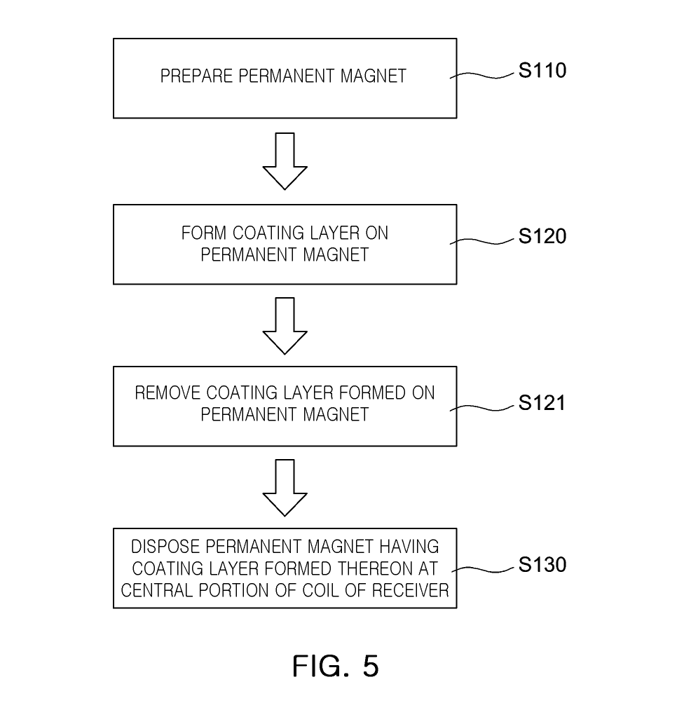

FIG. 4 is a flow chart of a method of fabricating a contactless power transmission device according to the embodiment of the present invention.

Referring to FIG. 4, the method of fabricating a contactless power transmission device 1 according to the embodiment of the present invention may include preparing a permanent magnet 10 (S110); forming a coating layer on the permanent magnet 10 (S120); and disposing the permanent magnet 10 at the center of a coil of a receiver of the contactless power transmission device 1 (S130).

The preparing (S110) of the permanent magnet 10 may be performed using any one of an Nd—Fe based magnet, Sm₂Co₁₇ based magnet, a ferrite magnet, and an alnico magnet, but is not limited thereto.

The forming (S120) of the coating layer may be performed using a material including at least one metal selected from a group consisting of iron, nickel, aluminum, silicon, cobalt, and zinc, or an alloy thereof, but is not limited thereto.

The forming (S120) of the coating layer performed using the material including at least one metal selected from a group consisting of iron, nickel, aluminum, silicon, cobalt, and zinc, or an alloy thereof may be performed by one of a molecular beam epitaxy (MBE) method, a sputtering method, an electroplating method, an alloying method, and a dip-coating method, but is not limited thereto.

The forming (S120) of the coating layer may be performed using a high magnetic permeability material including at least one of a sendust (Fe—Si—Al alloy) based high magnetic permeability material, a permalloy based high magnetic permeability material, and an amorphous based high magnetic permeability material, but is not limited thereto.

The forming (S120) of the coating layer performed using the high magnetic permeability material including at least one of the sendust (Fe—Si—Al alloy) based high magnetic permeability material, the permalloy based high magnetic permeability material, and the amorphous based high magnetic permeability material may be performed by one of an MBE method, a sputtering method, an electroplating method, an alloying method, and a dip-coating method, but is not limited thereto.

The forming (S120) of the coating layer may be performed so that the coating layer has a coating thickness t of 0.1 to 1.0 mm.

The coating thickness t may be adjusted by the above-mentioned respective processes or be adjusted by forming the coating layer to have a required thickness or more and then partially removing the coating layer.

The method of fabricating a contactless power transmission device 1 according to the embodiment of the present invention may further include, after the forming (S120) of the coating layer, removing (S121) the coating layer 11 formed on the permanent magnet 10.

The removing of the coating layer 11 formed on the permanent magnet 10 may be performed by one of a polishing method, a grinding method, and an etching method, but is not limited thereto.

The contactless power transmission device and the method of fabricating the same according to the embodiments of the present invention described above are not limited to the above-mentioned embodiments, but may be variously applied.

In addition, although the contactless power receiver used in the electronic apparatus has been described in the above-mentioned embodiments by way of example, the contactless power receiver according to the embodiments of the present invention is not limited thereto, but may be widely used in all electronic apparatuses capable of being used by charging power therein and all power transmission devices capable of transmitting the power.

As set forth above, according to the embodiments of the present invention, the permanent magnet capable of allowing the coil of the contactless power receiver and the coil of the contactless power transmitter to coincide and increasing the efficiency of the contactless power receiver may be provided.

While the present invention has been shown and described in connection with the embodiments, it will be apparent to those skilled in the art that modifications and variations can be made without departing from the spirit and scope of the invention as defined by the appended claims.

What is claimed is:

1. A contactless power transmission device comprising:
a permanent magnet disposed at a center of a coil of a receiver in order to allow the center of the coil of the receiver and a center of a coil of a transmitter to coincide; and
a coating layer formed on a surface of the permanent magnet.

2. The contactless power transmission device of claim 1, wherein the coating layer includes at least one metal selected from a group consisting of iron, nickel, aluminum, silicon, cobalt, and zinc, or an alloy thereof.

3. The contactless power transmission device of claim 1, wherein the coating layer includes at least one of a sendust (Fe—Si—Al alloy) based high magnetic permeability material, a permalloy based high magnetic permeability material, and an amorphous based high magnetic permeability material.

4. The contactless power transmission device of claim 1, wherein a thickness of the coating layer is 0.1 to 1.0 mm.

5. The contactless power transmission device of claim 1, wherein a diameter of an outermost portion of the coating layer is 10 to 30 mm.

6. The contactless power transmission device of claim 1, wherein the coating layer is formed on a cylindrical surface of the permanent magnet.

7. The contactless power transmission device of claim 1, wherein the permanent magnet has a cylindrical shape or a rectangular parallelepiped shape.

8. The contactless power transmission device of claim 1, being operated in a frequency range of 10 to 20,000 kHz.

9. A method of fabricating a contactless power transmission device, the method comprising:
preparing a permanent magnet;
forming a coating layer on the permanent magnet; and
disposing the permanent magnet having the coating layer formed thereon at a central portion of a coil of a receiver.

10. The method of claim 9, wherein the forming of the coating layer is performed using at least one metal selected from a group consisting of iron, nickel, aluminum, silicon, cobalt, and zinc, or an alloy thereof.

11. The method of claim 9, wherein the forming of the coating layer is performed using a high magnetic permeability material including at least one of a sendust (Fe—Si—Al alloy) based high magnetic permeability material, a permalloy based high magnetic permeability material, and an amorphous based high magnetic permeability material.

12. The method of claim 10, wherein the forming of the coating layer is performed by one of a molecular beam epitaxy (MBE) method, a sputtering method, an electroplating method, an alloying method, and a dip-coating method.

13. The method of claim 11, wherein the forming of the coating layer is performed by one of a hydrothermal synthesis method, a pulsed laser deposition (PLD) method and an atomic layer deposition (ALD) method.

14. The method of claim 9, wherein in the forming of the coating layer, the coating layer is coated at a coating thickness of 0.1 to 1.0 mm.

15. The method of claim 9, further comprising, after the forming of the coating layer, removing the coating layer formed on the permanent magnet.

16. The method of claim 9, wherein in the preparing of the permanent magnet, the permanent magnet having a cylindrical shape or a rectangular parallelepiped shape is prepared.
